(19) United States
(12) Patent Application Publication
(10) Pub. No.: US 2014/0152472 A1
(43) Pub. Date: Jun. 5, 2014

(54) OBJECT LOCATION CONFIRMATION SYSTEM

(71) Applicant: INSTITUTE FOR INFORMATION INDUSTRY, Taipei (TW)

(72) Inventors: Sheng-Po TSENG, Hsinchu City (TW); Shih-Yao DAI, Taipei City (TW)

(73) Assignee: INSTITUTE FOR INFORMATION INDUSTRY, Taipei (TW)

(21) Appl. No.: 13/714,247

(22) Filed: Dec. 13, 2012

(30) Foreign Application Priority Data
Dec. 3, 2012 (TW) 101145239

(51) Int. Cl. G08G 1/14

(52) U.S. Cl. CPC G08G 1/14
USPC 340/932.2; 340/933; 340/937

(57) ABSTRACT

An object location confirmation system for use in an area is provided. The area includes a first zone and a second zone. The object location confirmation system includes a first retrieving device, a second retrieving device, and a data processing apparatus. The first retrieving device is disposed on a path of the area to retrieve a first datum of an object. The second retrieving device is disposed in a boundary region of the second zone. The data processing apparatus is configured to receive the first datum and identify the first datum so as to generate a piece of identification information related to the object. The data processing apparatus determines and records that the object is located in the first zone when the data processing apparatus receives the identification information related to the object and has not received a second datum of the object retrieved from the second retrieving device.

### PRIORITY

This application claims priority to Taiwan Patent Application No. 101145239 filed on Dec. 3, 2012, the entirety of which is hereby incorporated by reference herein in its entirety.

### FIELD

The present invention relates to an object location confirmation system. More particularly, the present invention relates to an object location confirmation system that confirms a location of an object by retrieving a piece of information related to the object and making a determination according to the retrieved information.

### BACKGROUND

To meet the demands for parking of numerous vehicles around large-scale shopping malls and in urban areas, large parking places are usually deployed around the large-scale shopping malls and in the urban areas. These large parking places provide capacious and multi-floor parking spaces to accommodate a lot of parking plots.

However, it is often difficult for users to determine the locations of their vehicles in such large parking places, so much time is spent in looking for the locations where the vehicles are originally parked. Furthermore, from the standpoint of the parking place managing staff, it is also impossible to accurately keep track of vacant parking plots in their parking places, which makes management of the parking places inconvenient.

On the other hand, in terms of public affairs, it is often necessary to confirm a location of a vehicle in a street, for example, when an illegal vehicle or a suspect is being chased. Also for commercial applications, sometimes shopping carts are placed anywhere by customers in marketplaces, and this necessitates use of additional labors to manage and collect the shopping carts, which adds to the management cost of the marketplaces.

Accordingly, an urgent need exists in the art to provide a solution capable of confirming locations of objects such as vehicles and shopping carts in an efficient way without the need of manual search.

### SUMMARY

An objective of the present invention is to provide an object location confirmation system. The object location confirmation system of the present invention uses retrieving/reading devices in an area to retrieve related data of an object in real time, identifies the related data to obtain identification information, and confirms the location of the object according to the identification information and relative locations of the retrieving/reading devices. Thereby, as compared to the prior art, the object location confirmation system of the present invention can confirm a location of a vehicle or some other objects in real time. This can improve the convenience in use or in management of parking places or other areas and further reduce waste of human resources and time.

To achieve the aforesaid objective, certain embodiments of the present invention provide an object location confirmation system for use in an area. The area includes a first zone and a second zone adjacent to the first zone. The object location confirmation system comprises a first retrieving device, a second retrieving device and a data processing apparatus. The first retrieving device is disposed on a path of the area, and is configured to retrieve a first datum related to an object. The second retrieving device is disposed in a boundary region of the second zone. The data processing apparatus is connected to the first retrieving device and the second retrieving device respectively, and is configured to identify the first datum to generate a piece of identification information corresponding to the object. When the data processing apparatus identifies the first datum and generates the identification information but has not received a second datum related to the object from the second retrieving device, the data processing apparatus determines and records that the object is located in the first zone.

To achieve the aforesaid objective, certain embodiments of the present invention further provide an object location confirmation system for use in an area. The area includes a first zone and a second zone adjacent to the first zone. The object location confirmation system comprises a first data reading device, a second data reading device and a data processing apparatus. The first data reading device is disposed on a path of the area, and is configured to retrieve a first datum related to an object and obtain a piece of identification information corresponding to the object according to the first datum. The second data reading device is disposed in a boundary region of the second zone. The data processing apparatus is connected to the first data reading device and the second data reading device respectively. When the data processing apparatus receives the identification information from the first data reading device but has not received the identification information from the second reading device by retrieving a second datum related to the object and obtaining the identification information corresponding to the object according to the second datum by the second data reading device, the data processing apparatus determines and records that the object is located in the first zone.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a block diagram of an object location confirmation system according to a first embodiment of the present invention;

FIG. 2A is a block diagram of an object location confirmation system according to a second embodiment of the present invention;

FIG. 2B to FIG. 2D are schematic views illustrating an area in the second embodiment of the present invention;

FIG. 3A is a block diagram of an object location confirmation system according to a third embodiment of the present invention;

FIG. 3B is a schematic view illustrating an area in the third embodiment of the present invention;

FIG. 4 is a block diagram of an object location confirmation system according to a fourth embodiment of the present invention;

FIG. 5A is a block diagram of an object location confirmation system according to a fifth embodiment of the present invention;

FIG. 5B is a schematic view illustrating an area in the fifth embodiment of the present invention;

FIG. 6A is a block diagram of an object location confirmation system according to a sixth embodiment of the present invention; and

FIG. 6B is a schematic view illustrating an area in the sixth embodiment of the present invention.

### DETAILED DESCRIPTION

In the following descriptions, the present invention will be explained with reference to example embodiments thereof. However, these example embodiments are not intended to limit the present invention to any specific example, embodiment, environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction; and dimensional relationships among individual elements in the attached drawings are illustrated only for ease of understanding, but not to limit the actual scale.

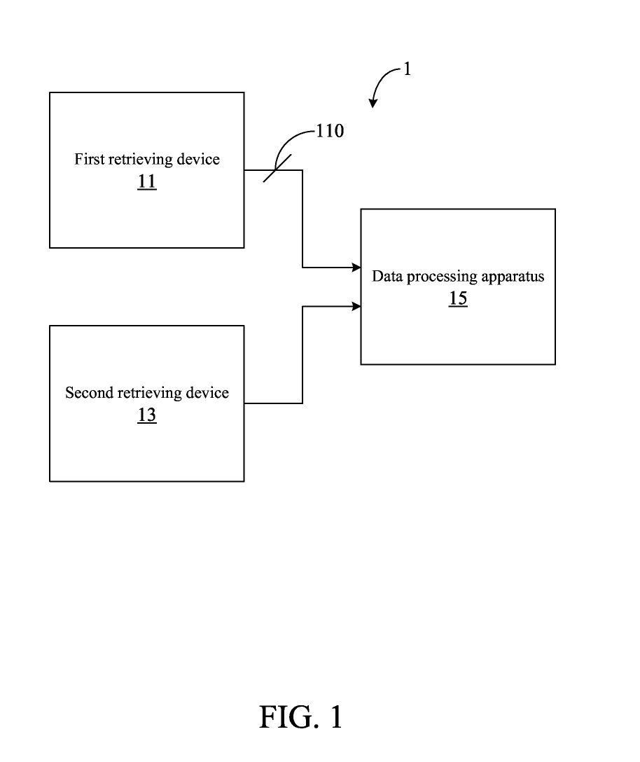

A first embodiment of the present invention is shown in FIG. 1, which depicts a functional block diagram of an object location confirmation system 1 according to the first embodiment. The object location confirmation system 1 is used in an area, and comprises a first retrieving device 11, a second retrieving device 13 and a data processing apparatus 15. The area includes a first zone and a second zone adjacent to the first zone. The area may be a parking place, a street, a shopping mall or the like. The first retrieving device 11 is disposed on a path of the area. Here, the path refers to a path through which the object will pass. The second retrieving device 13 is disposed in a boundary region of the second zone. Here, the term “adjacent to” may means that the second zone is adjacent to the first zone in a two-dimensional (2D) plane or in a three-dimensional (3D) space. The object location confirmation system 1 may adopt an image recognition technology or a radio frequency identification (RFID) technology to confirm a location of an object.

As shown in FIG. 1, the data processing apparatus 15 is connected to the first retrieving device 11 and the second retrieving device 13 in a wired or wireless way, for example, through RS-232, Universal Serial Bus (USB), a wired network or Wireless Fidelity (Wi-Fi).

When an object enters into a data retrieving range of the first retrieving device 11, the first retrieving device 11 retrieves a first datum 110 related to the object and then transmits the first datum 110 to the data processing apparatus 15.

Then, the data processing apparatus 15 identifies the first datum 110 from the first retrieving device 11 and generates a piece of identification information (not shown) corresponding to the object. At this point, the object has not entered into a data retrieving range of the second retrieving device 13 and, of course, the second retrieving device 13 has not retrieved a second datum related to the object. From the viewpoint of the data processing apparatus 15, the data processing apparatus 15 has only received the first datum 110 from the first retrieving device 11 and obtained the identification information corresponding to the first datum 110. Accordingly, the data processing apparatus 15 determines and records that the object is located in the first zone.

As can be known from the above descriptions, the object location confirmation system 1 of the present invention determines and records the location of an object by using the first retrieving device 11 to retrieve the first datum 110 and using the data processing apparatus 15 to identify the first datum 110.

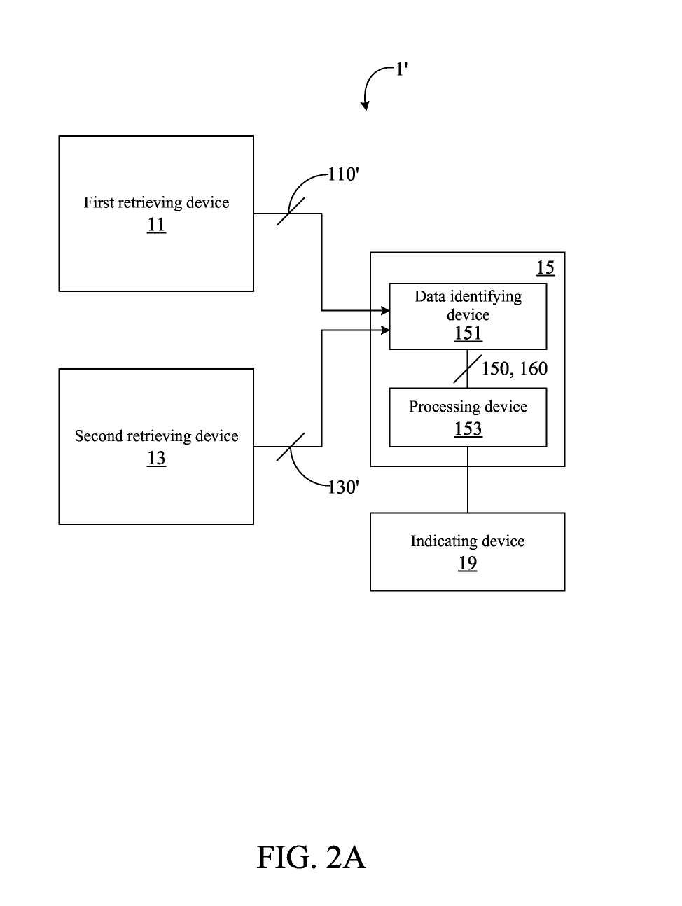

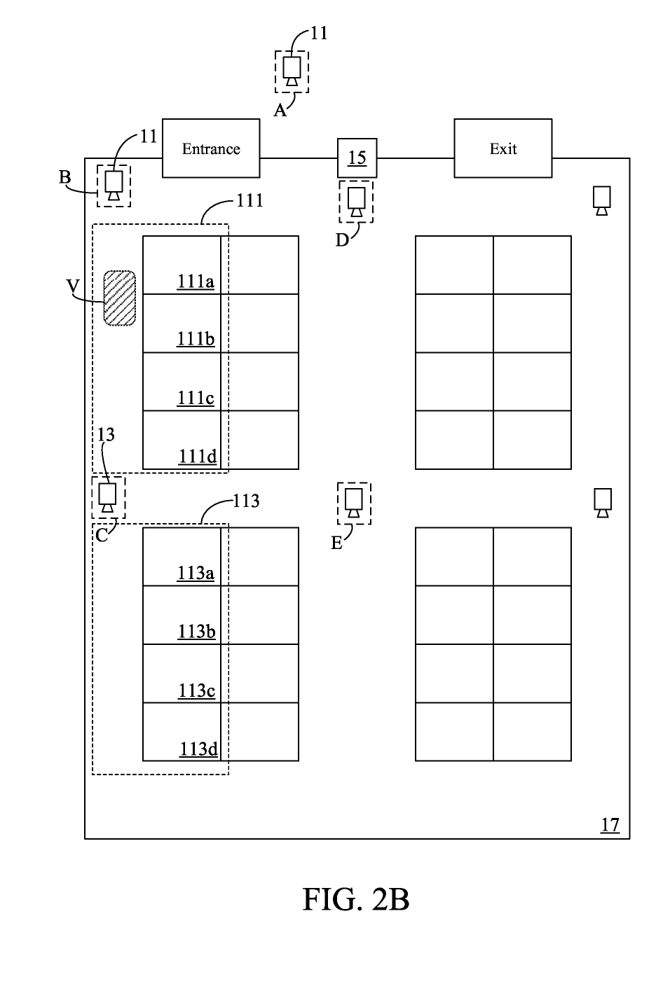

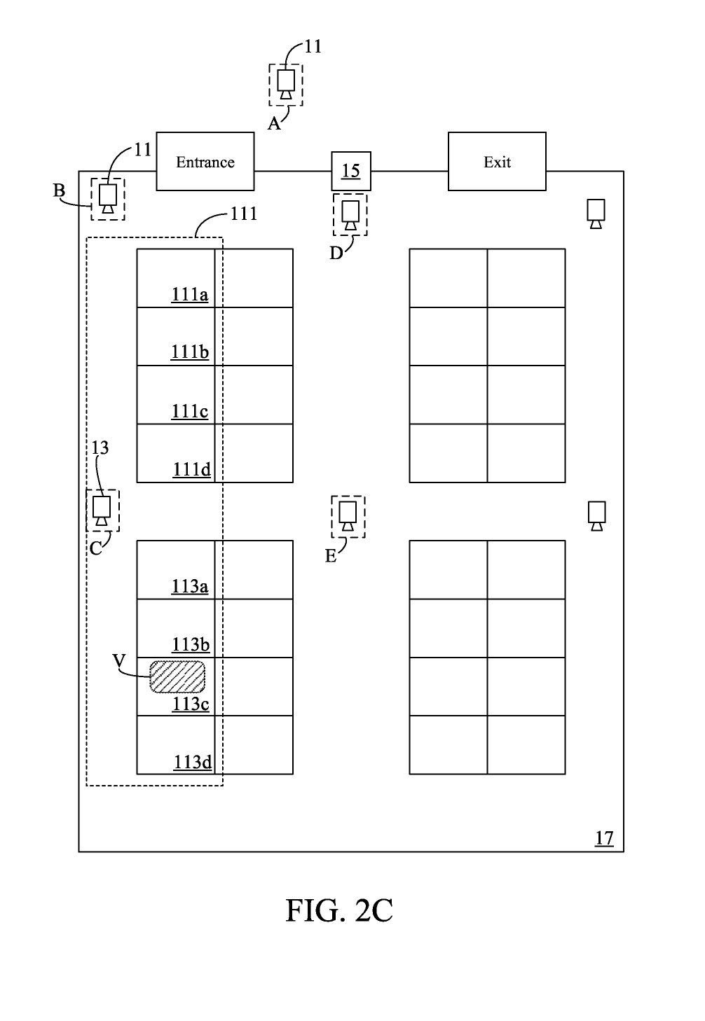

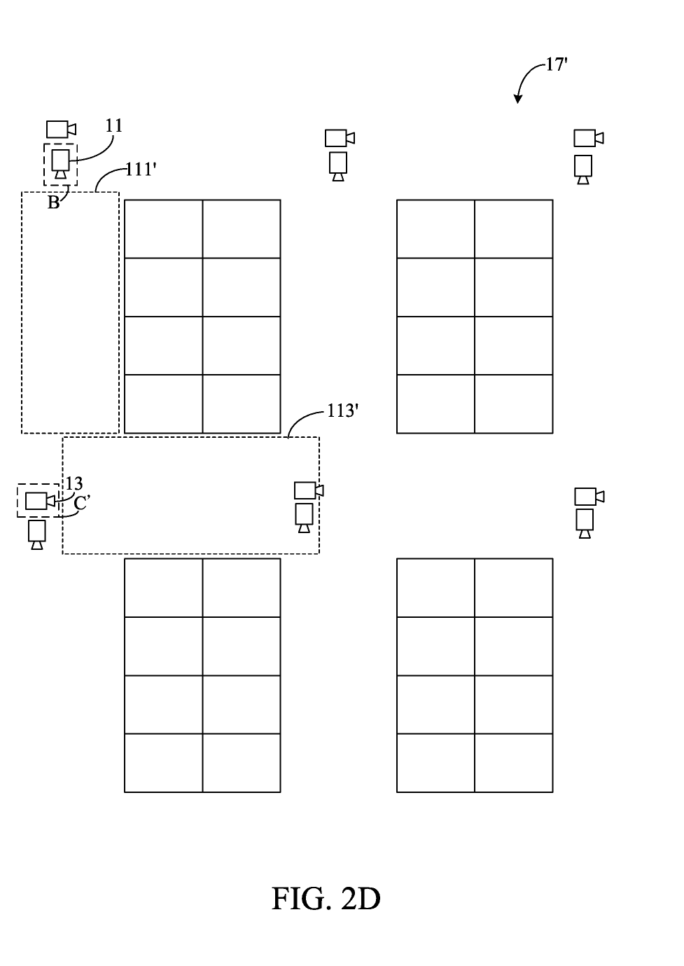

A second embodiment of the present invention is shown in FIG. 2A to FIG. 2D. FIG. 2A depicts a functional block diagram of an object location confirmation system 1′ according to the second embodiment, and FIG. 2B to FIG. 2D depicts a schematic view of an area in which the object location confirmation system 1′ is used. It shall be appreciated that, the object location confirmation system 1′ of this embodiment adopts an image recognition technology to confirm a location of a vehicle V. The area may be a parking place 17. However, the present invention is not limited to this, and it will be appreciated by those of ordinary skill in the art that, other means that adopt similar technologies to achieve the purpose of this embodiment shall all fall within the scope of the present invention.

Firstly, referring to FIG. 2A, the object location confirmation system 1′ is used in a parking place 17, and comprises a first retrieving device 11, a second retrieving device 13, a data processing apparatus 15 and an indicating device 19. The data processing apparatus 15 further comprises an information identifying device 151 and a processing device 153. The information identifying device 151 is connected to the processing device 153 through RS-232, USB, a wired network or Wi-Fi. Alternatively, the information identifying device 151 and the processing device 153 may also be electrically connected through a circuit, and the processing device 153 may be connected to the indicating device 19 either in a wired or wireless way.

Next, please refer to FIG. 2B and FIG. 2C together. The parking place 17 includes a first zone 111 and a second zone 113 adjacent to the first zone 111. In this embodiment, each of the first zone 111 and the second zone 113 is preset to comprise four parking plots, which are 111a, 111b, 111c, 111d, 113a, 113b, 113c and 113d respectively. However, the present invention is not limited to this, and in other embodiments, the first zone and the second zone may comprise only a single parking plot or a plurality of parking plots.

It shall be appreciated that, each of the first retrieving device 11 and the second retrieving device 13 is a video camera, and each of the video cameras has a code name so that the data processing apparatus 15 can confirm locations of the retrieving devices by means of the code names in conjunction with a map of the parking place 17. The information identification apparatus 151 is a server having an optical character recognition (OCR) function and a data processing function.

The first retrieving device 11 is disposed on a lane of the parking place 17, for example, at a location A of a lane at the entrance or at a location B in a boundary region of the first zone 111. In this embodiment, the second retrieving device 13 is disposed at a location C in a border region where the first zone 111 borders the second zone 113.

Firstly, when the vehicle V enters into an image retrieving range of the first retrieving device 11 located at the location A or the location B, the first retrieving device 11 retrieves a first datum (i.e., a first image 110′ of the vehicle V) related to the vehicle V. Then, the first retrieving device 11 transmits the first image 110′ to the information identifying device 151. The information identifying device 151 performs OCR recognition on the first image 110′ to generate identification information (i.e., a vehicle license plate identification code 150) corresponding to the vehicle V. At this point, the vehicle has not entered into an image retrieving range of the second retrieving device 13 located at the location C and, of course, the second retrieving device 13 has not retrieved the second datum (i.e., a second image 130′ of the vehicle V). Accordingly, the processing device 153 determines and records that the vehicle V is located in the first zone 111 after receiving the vehicle license plate identification code 150 of the vehicle V that correspond to the first image 110′.

On the other hand, if the vehicle V enters into the image retrieving range of the second retrieving device 13 located at the location C, then the second retrieving device 13 retrieves the second image 130′ of the vehicle V and transmits the second image 130′ to the information identifying device 151. Then, the information identifying device 151 further performs OCR recognition on the second image 130′ to obtain the vehicle license plate identification code 150 of the vehicle V and transmits the vehicle license plate identification code 150 to the processing device 153. At this point, a third retrieving device (not shown), for example, a retrieving device located at a location E, has not retrieved a third image (not shown) of the vehicle yet. Accordingly, the processing device 153 determines and records that the vehicle V is located in the second zone 113 after receiving the vehicle license plate identification code 150 of the vehicle V that corresponds to the second image 130′.

Furthermore, in order to confirm the location of the vehicle V more accurately, the object location confirmation system 1′ further obtains a piece of auxiliary identification information of the vehicle V to further assist in confirmation of the location of the vehicle V. In detail, when the vehicle enters into the second zone 113 and closely follows a green car that shields the vehicle license plate of the vehicle V, it will be impossible to recognize the vehicle license plate identification code 150 of the vehicle V from the second image 130′ retrieved by the second retrieving device 13. Accordingly, when receiving the first image 110′ retrieved by the first retrieving device 11, the information identifying device 151 not only recognizes the vehicle license plate identification code 150 of the vehicle V according to the first image 110′, but also identifies a vehicle color (e.g., red) of the vehicle V as auxiliary identification information 160.

Thus, in the case where the green vehicle shields the vehicle license plate of the vehicle V to make it impossible for the second retrieving device 13 to retrieve a second image 130′ comprising the vehicle license plate identification code 150 of the vehicle V and further make it impossible to recognize the vehicle license plate identification code of the vehicle V according to the second image 130′, the information identifying device 151 can still identify the color of the vehicle V as a red color according to the second image 130′. This auxiliary identification information is identical to the auxiliary identification information 160 identified according to the first image 110′. Accordingly, as shown in FIG. 2C, the processing device 153 incorporates the second zone 113 into the first zone 111. Then, the first zone 111 will include the parking plots 111a-111d and 113a-113d. Therefore, the range of the first zone 111 changes dynamically, and now the vehicle V is still determined to be located in the first zone 111.

Additionally, the auxiliary identification information 160 may also be a manufacturer's brand of the vehicle V, which is obtained by identifying a manufacturer's brand symbol on the vehicle. However, the attributes of the auxiliary identification information described above are only for purpose of illustration but is not intended to limit the scope of the invention.

In this embodiment, the location A or location B of the first retrieving device 11 and the location C of the second retrieving device 13 are only provided for purpose of illustration but not for purpose of limitation. The first retrieving device 11 and the second retrieving device 13 may be arranged according to the topography of the parking place 17 and practical needs. For example, in other embodiments, the first retrieving device may also be arranged at the location D and the second retrieving device may also be arranged at the location E. In this case, the first zone includes eight parking plots in total that are arranged at two sides of the image retrieving range of the first retrieving device, and the second zone includes eight parking plots in total that are arranged at two sides of the image retrieving range of the second retrieving device. Further in other embodiments, the object location confirmation system 1′ may also provide an additional first retrieving device and/or an additional second retrieving device to assist the first retrieving device 11 and the second retrieving device 13 in retrieval of the first image 110′ and the second image 130′.

For example, if the vehicle V is a motorcycle, the vehicle license plate thereof is usually installed at a rear portion thereof; or the identification information may be a parking permit serial number assigned by a management system, and a parking permit having the parking permit serial number is usually affixed to a front portion of the vehicle V (e.g., the windscreen of the vehicle). In this case, the additional first retrieving device and/or the additional second retrieving device (not shown) may be arranged in the object location confirmation system 1′ to assist the first retrieving device 11 and the second retrieving device 13 in retrieving the first image 110′ and the second image 130′.

The additional first retrieving device may be arranged in a boundary region of the first zone 111 opposite to the first retrieving device 11, and the additional second retrieving device may be arranged in another boundary region of the second zone 113 opposite to the second retrieving device 13. How the additional first retrieving device and/or the additional second retrieving device assist the first retrieving device 11 and the second retrieving device 13 in retrieving images will be readily known by those of ordinary skill in the art, so it will not be further described herein.

Another example where the object location confirmation system 1′ is used in a street 17′ is shown in FIG. 2D. This example differs from the previous example where the area is a parking place 17 in that, the street 17′ does not has an entrance as in the parking place 17. Therefore, the first zone 111′ and the second zone 113′ are a section of a lane and an arcade region beside the lane respectively; and the first retrieving device 11 is arranged at the location B in a boundary region of the first zone 111′, and the second retrieving device 13 is arranged at a location C′ in a border region where the first zone 111′ borders the second zone 113′. Other elements of the object location confirmation system 1′ and functions thereof in this example are all the same as those of the previous example where the area is a parking place, so no further description will be made herein.

It shall be appreciated that, the processing device 153 may further comprise a storage device (not shown) and a counter (not shown). The storage device is configured to store the map of the parking place 17 and record location information of the vehicle V in the first zone 111. The counter is configured to record the number of vacant parking plots in each of the first zone 111, the second zone 113 and other zones. For example, when the processing device 153 determines that the vehicle V is located in the first zone 111 and the number of vacant parking plots is greater than zero, then the number of vacant parking plots in the first zone 111 is decreased by one. Thereby, the parking place management staff can keep track of the number of vacant parking plots of each zone according to the count of the counter.

On the other hand, when the user is searching for the vehicle V, he or she may be informed of the location of the vehicle V by an indicating message from the indicating device 19. For example, the indicating device 19 may be a display screen of an auto pay station (APS) disposed in the parking place, or a smart phone that is wirelessly connected to the processing device 153 through Wi-Fi. After receiving the location message related to the vehicle V from the processing device 153, the indicating device 19 displays the indicating message according to the map of the parking place 17 and the location message to indicate that the vehicle V is located in the first zone 111 on the map. Alternatively, the indicating device 19 may be a loud speaker which expresses the indicating message in an audio form to indicate that the vehicle V is located in the first zone 111.

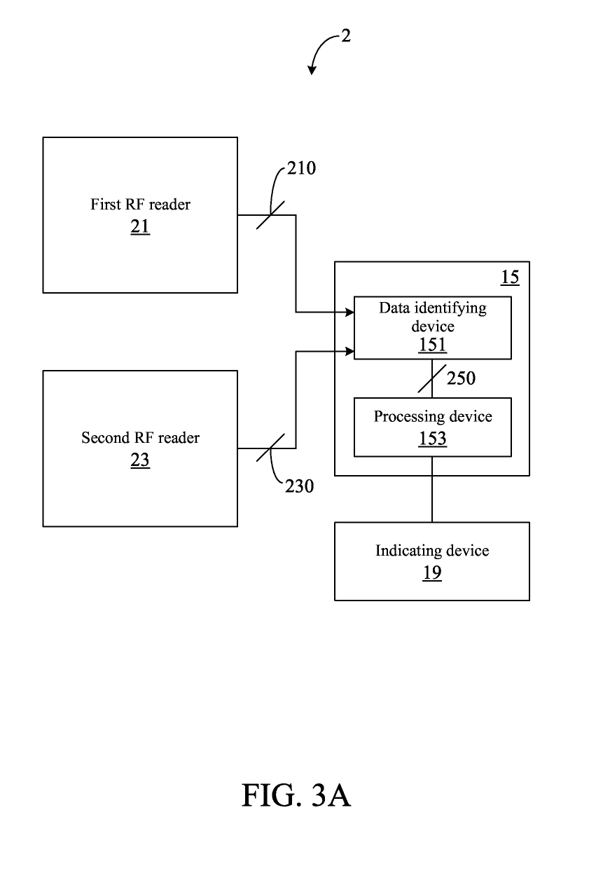

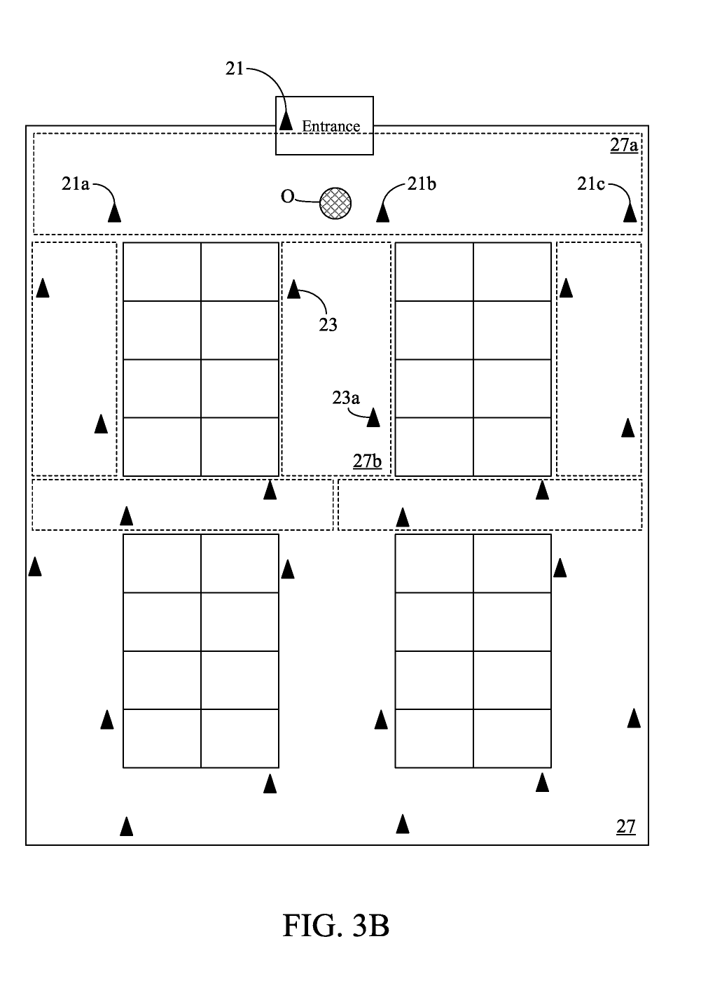

A third embodiment of the present invention is shown in FIG. 3A and FIG. 3B. FIG. 3A depicts a functional block diagram of an object location confirmation system 2 according to the third embodiment, and FIG. 3B is a schematic view illustrating an area in which the object location confirmation system 2 is used. The area may be a shopping mall 27 comprising a first zone 27a and a second zone 27b adjacent to the first zone 27a. It shall be particularly appreciated that, the object location confirmation system 2 of this embodiment adopts an RFID technology; and the object location confirmation system 2 comprises a first radio frequency (RF) reader 21, a second RF reader 23, a data processing apparatus 15 and an indicating device 19. The first RF reader 21 is disposed at an entrance of the shopping mall 27, and the second RF reader 23 is disposed in a boundary region within the second zone 27b.

Each of the first RF reader 21 and the second RF reader 23 has a reading range (not shown). Each of the reading ranges has a code name so that the data processing apparatus 15 can confirm locations of the retrieving devices by means of the code names in conjunction with a map of the shopping mall. The data processing apparatus 15 further comprises an information identifying device 151 and a processing device 153. The information identifying device 151 is connected to the first RF reader 21 and the second RF reader 23 in a wired or wireless way. Connections between the information identifying device 151, the processing device 153 and the indicating device 19 are the same as those of the second embodiment and, thus, will not be further described herein.

As shown in FIG. 3B, when an object (e.g., a shopping cart) enters through an entrance into the shopping mall 27 and further into the reading range of the first RF reader 21, the first RF reader 21 senses an RFID tag (not shown) affixed on the object O to receive a first datum, i.e., a first RF signal 210, and transmits the first RF signal 210 to the information identifying device 151. Then, the information identifying device 151 identifies the first RF signal 210 to obtain a piece of identification information, i.e., an RFID code 250. At this point, the object O has not entered into the reading range of the second RF reader 23, so the second RF reader 23 has not sensed the RFID tag of the object O to obtain a second datum (i.e., a second RF signal 230). Accordingly, the processing device 153 determines and records that the object O is located in the first zone 27a according to the RFID code 250 corresponding to the first RF signal 210.

Further speaking, if the object O continues to move towards the second zone 27b so that the RFID tag of the object O is sensed by the second RF reader 23 and the second RF signal 230 is received by the second RF reader 23 but the RFID tag of the object O has not been sensed by a third RF reader (not shown) disposed in a boundary region within the third zone adjacent to the second zone 27b, then the information identifying device 151 identifies the second RF signal 230 to obtain the RFID code 250 in a similar way. Then, the processing device 153 determines and records that the object O is located in the second zone 27b according to the RFID code 250 corresponding to the second RF signal 230.

On the other hand, the management staff of the shopping mall who is searching for the object O can be informed of the location of the object O by an indicating message from the indicating device 19. For example, the indicating device 19 may be a display screen of the data processing apparatus 15, or a smart phone that is wirelessly connected to the processing device 153 through Wi-Fi. After receiving a location message related to the object O from the processing device 153, the indicating device 19 displays the indicating message according to a map of the shopping mall 27 and the location message to indicate that the object O is located in the second zone 27b on the map. Alternatively, the indicating device 19 may be a loud speaker which expresses the indicating message in an audio form to indicate that the object O is located in the second zone 27b.

The object location confirmation system 2 may also provide other first RF readers to assist in retrieving the first RF signal 210 (e.g., first RF readers 21a, 21b and 21c shown in FIG. 3B) and other second RF readers to assist in retrieving the second RF signal 230 (e.g., the second RF reader 23a shown in FIG. 3B). How this is accomplished will be readily appreciated by those of ordinary skill in the art and, thus, will not be further described herein.

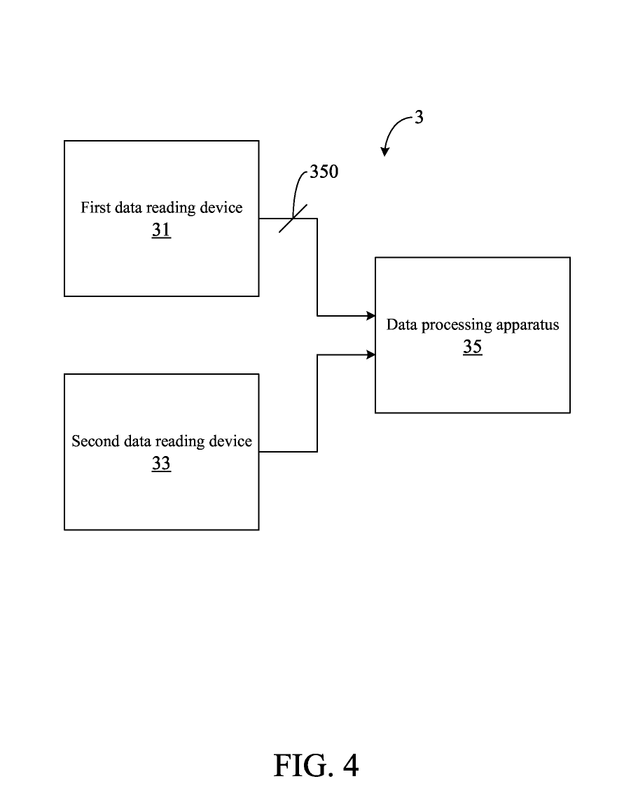

A fourth embodiment of the present invention is shown in FIG. 4, which is a schematic view of an object location confirmation system 3 according to the fourth embodiment. The object location confirmation system 3 is used in an area which, for example, includes a first zone and a second zone adjacent to the first zone. The object location confirmation system 3 comprises a first data reading device 31, a second data reading device 33 and a data processing apparatus 35. The data processing apparatus 35 is connected to the first data reading device 31 and the second data reading device 33 respectively in a wired or wireless way, for example, through RS-232, USB, a wired network or Wi-Fi. The first data reading device 31 is arranged on a path of the area, and the second data reading device 33 is arranged in the second zone.

When an object enters into the first zone, the first data reading device 31 retrieves a first datum (not shown) related to the object and obtains a piece of identification information 350 corresponding to the object according to the first datum. Then, the first data reading device 31 transmits the identification information 350 to the data processing apparatus 35.

Then, the identification information 350 is received by the data processing apparatus 35 from the first data reading device 31. Because the object has not entered into the data retrieving range of the second data reading device 33, the second data reading device 33 has not retrieved a second datum related to the object and, of course, has not obtained the identification information 350 corresponding to the object. From the viewpoint of the data processing apparatus 35, only the identification information 350 from the first data reading device 31 has been obtained. Accordingly, the data processing apparatus 35 determines and records that the object is located in the first zone.

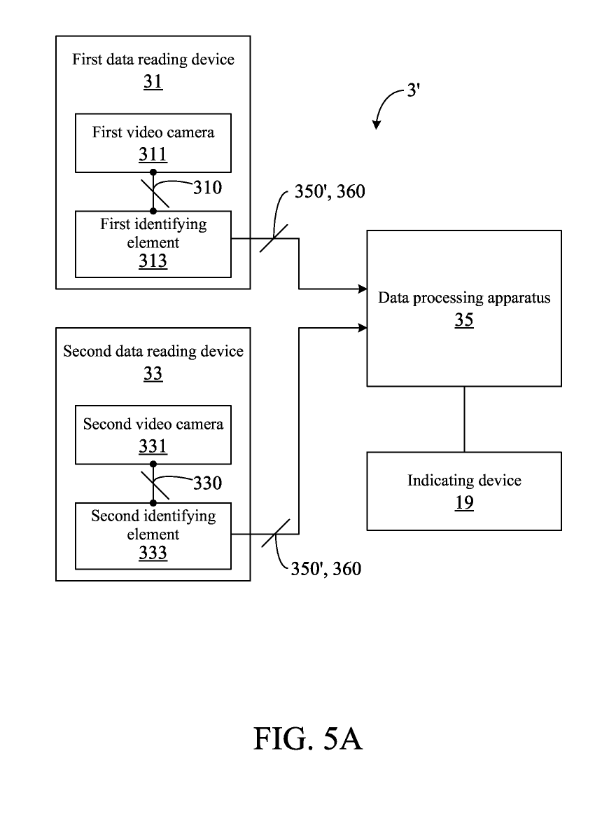

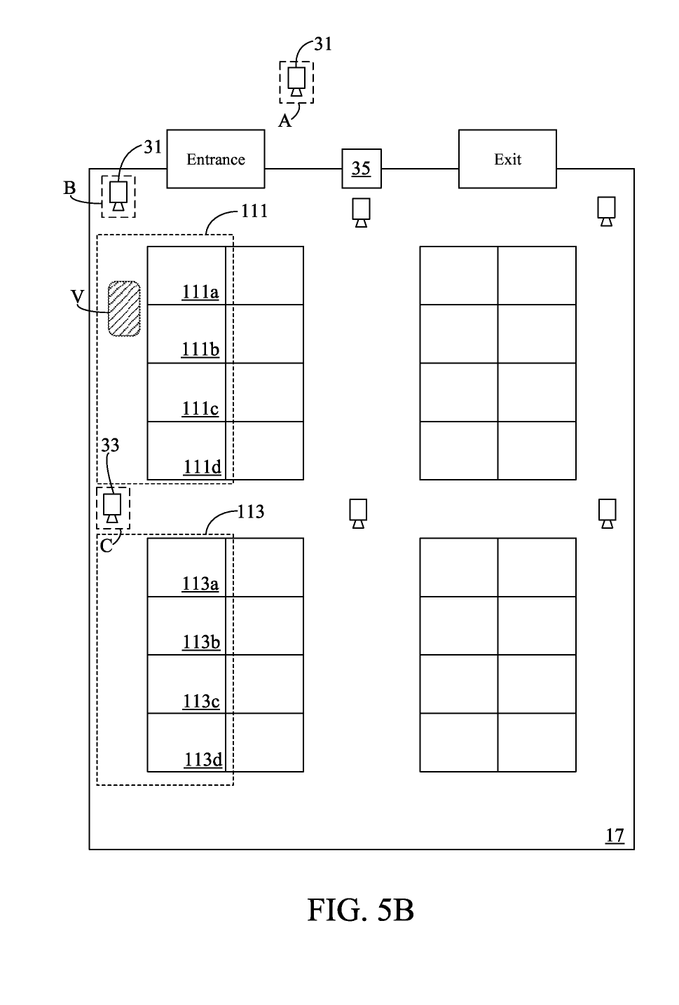

A fifth embodiment of the present invention is shown in FIG. 5A and FIG. 5B. FIG. 5A is a functional block diagram of an object location confirmation system 3′ according to the fifth embodiment, and FIG. 5B is a schematic view of an area in which the object location confirmation system 3′ is used. It shall be particularly appreciated that, the object location confirmation system 3′ of this embodiment adopts an image recognition technology to confirm a location of a vehicle V. In the fifth embodiment, the area is also a parking place 17 as in the second embodiment, so the parking place 17 will not be further described herein.

In this embodiment, the object location confirmation system 3′ used to confirm a location of an object comprises a first data reading device 31, a second data reading device 33, a data processing apparatus 35 and an indicating device 19; and the object is a vehicle V. The first data reading device 31 is arranged on a lane of the parking place 17, for example, at a location A on a lane at an entrance or at a location B in a boundary region of the first zone 111. In this embodiment, the second data reading device 33 is disposed at a location C in a border region where the first zone 111 borders the second zone 113.

As shown in FIG. 5A, the first data reading device 31 comprises a first video camera 311 and a first identifying element 313 electrically connected to the first video camera 311. Likewise, the second data reading device 33 comprises a second video camera 331 and a second identifying element 333 electrically connected to the second video camera 331. The data processing apparatus 35 is connected to the first identifying element 313 and the second identifying element 333 respectively in a wired or wireless way, for example, through RS-232, USB, a wired network or Wi-Fi.

Referring to FIG. 5B together, when the vehicle V enters into the first zone 111, the first video camera 311 retrieves a first datum (i.e., a first image 310) related to the vehicle V. Then, the first identifying element 313 performs OCR recognition on the first image 310 to generate a piece of identification information (i.e., a vehicle license plate identification code 350′) corresponding to the vehicle V. Then, the first identifying element 313 transmits the vehicle license plate identification code 350′ to the data processing apparatus 35.

Then, the vehicle license plate identification code 350′ from the first identifying element 313 is received by the data processing apparatus 35. At this point, the vehicle V has not entered into an image retrieving range of the second video camera 331; in other words, the second video camera 331 has not retrieved a second datum (i.e., a second image 330) related to the vehicle V. Accordingly, the data processing apparatus 35 determines and records that the vehicle V is located in the first zone 111 according to the vehicle license plate identification code 350′ from the first identifying element 313.

On the other hand, in order to confirm the location of the vehicle V more accurately, the object location confirmation system 3′ further obtains a piece of auxiliary identification information 360 of the vehicle V to further assist in confirmation of the location of the vehicle V. The auxiliary identification information 360 may be a vehicle's color or a manufacturer's brand, and is obtained by the first identifying element 313 and the second identifying element 333 through identifying the first image 310 and the second image 330 respectively. The way in which the auxiliary identification information 360 is obtained is just as described in the second embodiment and, thus, will not be further described herein.

Furthermore, the data processing apparatus 35 may further comprise a storage device (not shown) and a counter (not shown). The storage device is configured to store the map of the parking place 17 and record location information of the vehicle V in the first zone 111. The counter is configured to record the number of vacant parking plots in each of the first zone 111, the second zone 113 and other zones. For example, when the data processing apparatus 35 determines that the vehicle V is located in the first zone 111 and the number of vacant parking plots is greater than zero, the number of vacant parking plots in the first zone 111 is decreased by one. Thereby, the parking place management staff can keep track of the number of vacant parking plots of each zone according to the count of the counter.

Furthermore, when the user is searching for the vehicle V, he or she may be informed of the location of the vehicle V by an indicating message from the indicating device 19. For example, the indicating device 19 may be a display screen of an auto pay station (APS) disposed in the parking place, or a smart phone that is wirelessly connected to the data processing apparatus 35 through Wi-Fi. After receiving the location message related to the vehicle V from the data processing apparatus 35, the indicating device 19 displays the indicating message according to the map of the parking place 17 and the location message to indicate that the vehicle V is located in the first zone 111 on the map. Alternatively, the indicating device 19 may be a loud speaker which expresses the indicating message in an audio form to indicate that the vehicle V is located in the first zone 111.

In summary, the fifth embodiment differs from the second embodiment in that, the identifying function of the data processing apparatus 15 in the second embodiment is shifted to the first data reading device 31 and the second data reading device 33 of the fifth embodiment. Therefore, those of ordinary skill in the art can be readily appreciated that, the object location confirmation system 3′ of the fifth embodiment can implement other corresponding operations and functions of the object location confirmation system 1′ of the second embodiment, and no further description will be made herein.

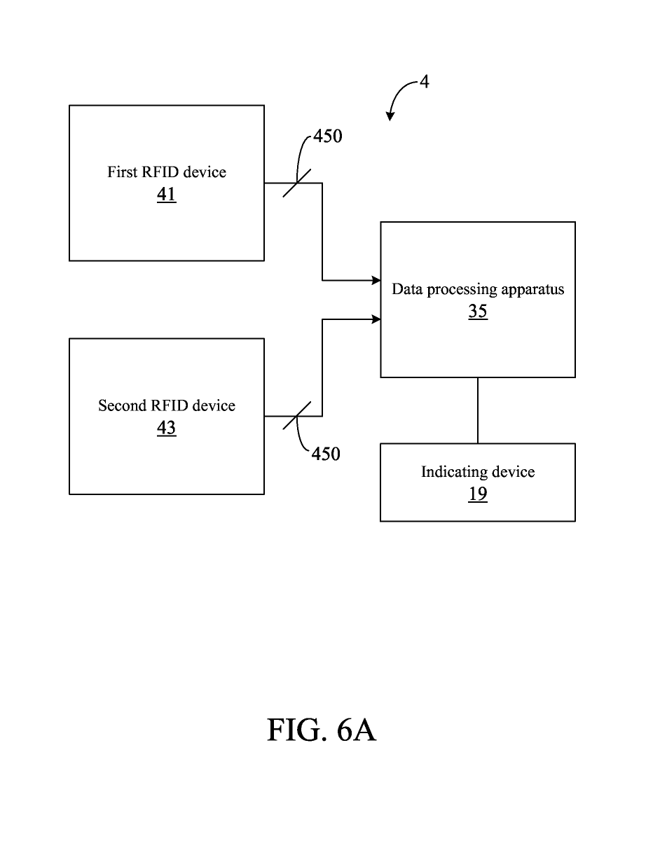

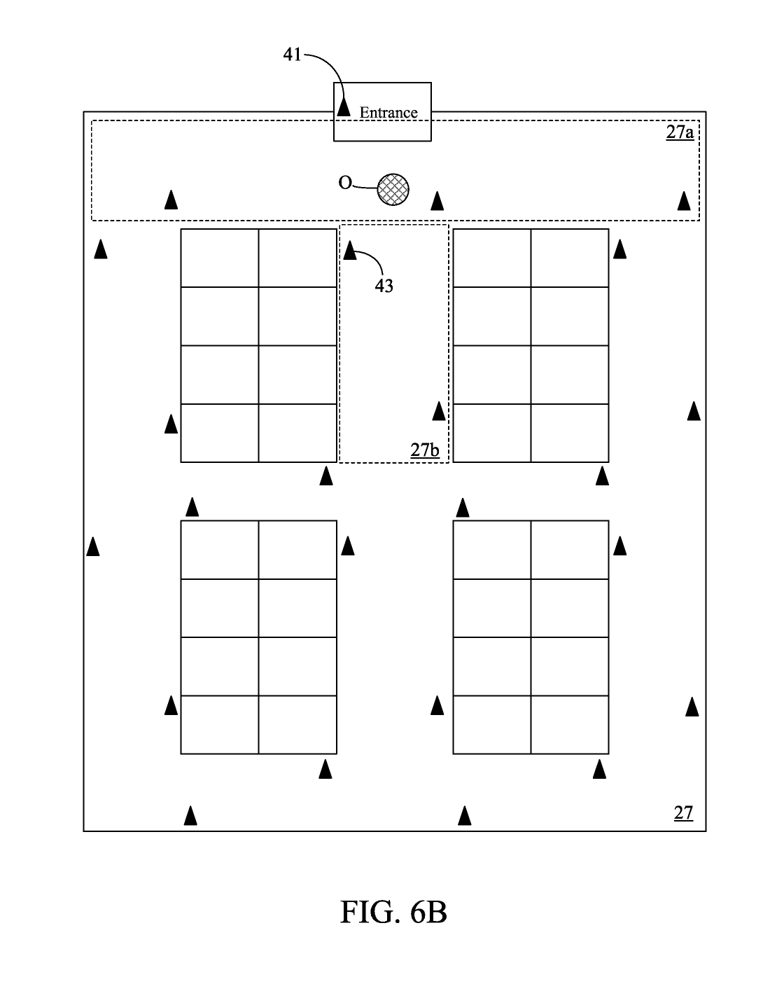

A sixth embodiment of the present invention is shown in FIG. 6A and FIG. 6B. FIG. 6A is a functional block diagram of an object location confirmation system 4 according to the sixth embodiment, and FIG. 6B is a schematic view of an area in which the object location confirmation system 4 is used. It shall be particularly appreciated that, the object location confirmation system 4 of this embodiment adopts an RFID technology; and the area in this embodiment is also a shopping mall 27 as in the third embodiment, so the shopping mall 27 will not be further described herein.

As shown in FIG. 6A, the object location confirmation system 4 comprises a first RFID device 41, a second RFID device 43 and a data processing apparatus 35. The data processing apparatus 35 is connected to the first RFID device 41 and the second RFID device 43 respectively in a wired or wireless way. The first RFID device 41 and the second RFID device 43 each have a reading range (not shown). The first RFID device 41 is disposed at an entrance of the shopping mall 27, and the second RFID device 43 is disposed in a boundary region within the second zone 27b.

Referring to FIG. 6B, when an object O (e.g., a shopping cart) enters through an entrance into the shopping mall 27, it will firstly move into the reading range of the first RFID device 41. Then, the first RFID device 41 senses an RFID tag (not shown) affixed on the object O to receive a first datum (i.e., a first RF signal) and identifies the first RF signal to generate an RFID code 450. At this point, the object O has not entered into the reading range of the second RFID device 23, so the second RFID device 43 has not sensed the RFID tag of the object O to obtain a second datum (i.e., a second RF signal). Accordingly, the data processing apparatus 153 determines and records that the object O is located in the first zone 27a according to the RFID code 450 corresponding to the first RF signal.

Further speaking, if the RFID tag of the object O is sensed by the second RFID device 43 and the second RF signal is received by the second RFID device 43 but the RFID tag of the object O has not been sensed by a third RFID device (not shown) disposed in a boundary region of the third zone adjacent to the second zone 27b, then the second RFID device 43 identifies the second RF signal to obtain the RFID code 450. Then, the data processing apparatus 35 determines and records that the object O is located in the second zone 27b according to the RFID code 450 corresponding to the second RF signal.

On the other hand, the management staff of the shopping mall who is searching for the object O can be informed of the location of the object O by an indicating message from the indicating device 19. For example, the indicating device 19 may be a display screen of the data processing apparatus 15, or a smart phone that is wirelessly connected to the data processing apparatus 35 through Wi-Fi. After receiving a location message related to the object O from the processing device 153, the indicating device 19 displays the indicating message according to a map of the shopping mall 27 and the location message to indicate that the object O is located in the second zone 27b on the map. Alternatively, the indicating device 19 may be a loud speaker which expresses the indicating message in an audio form to indicate that the object O is located in the second zone 27b.

In summary, the sixth embodiment differs from the third embodiment in that, the identifying function of the data processing apparatus 15 in the third embodiment is shifted to the first RFID device 41 and the second RFID device 43 in the sixth embodiment. Therefore, those of ordinary skill in the art can be readily appreciated that, the object location confirmation system 4 of the sixth embodiment can implement other corresponding operations and functions of the object location confirmation system 2 of the third embodiment, and no further description will be made herein.

As can be known from the above descriptions, the object location confirmation system of the present invention can determine a location of an object through appropriate arrangement of retrieving devices/reading devices in an area and by using the data processing apparatus to retrieve/read data from the retrieving devices/reading devices. This allows the user to search for the object or make management on the area with further reduced time consumption and expense.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An object location confirmation system for use in an area, the area including a first zone and a second zone adjacent to the first zone, the object location confirmation system comprising:
a first retrieving device disposed on a path of the area, being configured to retrieve a first datum related to an object;
a second retrieving device disposed in a boundary region of the second zone; and
a data processing apparatus connected to the first retrieving device and the second retrieving device respectively, being configured to identify the first datum to generate a piece of identification information corresponding to the object, wherein when the data processing apparatus identifies the first datum and generates the identification information but has not received a second datum related to the object from the second retrieving device, the data processing apparatus determines and records that the object is located in the first zone.

2. The object location confirmation system as claimed in claim 1, wherein each of the first retrieving device and the second retrieving device is a radio frequency (RF) reader, the first datum and the second datum are a first RF signal and a second RF signal from a radio frequency identification (RFID) tag of the object respectively, and the identification information is an RFID code.

3. The object location confirmation system as claimed in claim 1, wherein the object is a vehicle, each of the first retrieving device and the second retrieving device is a video camera, each of the first datum and the second datum is an image, and the identification information is one of a vehicle license plate identification code and a parking permit serial number.

4. The object location confirmation system as claimed in claim 3, wherein:
the second retrieving device is configured to retrieve the second datum of the vehicle;
the data processing apparatus further generates a piece of auxiliary identification information related to the vehicle when identifying the first datum, identifies the second datum to generate the auxiliary identification information corresponding to the vehicle, and incorporates the second zone into the first zone according to the auxiliary identification information generated by identifying the first datum and the second datum respectively; and
the auxiliary identification information is one of a color and a manufacturer's brand of the vehicle.

5. The object location confirmation system as claimed in claim 3, wherein the data processing apparatus further comprises a counter configured to calculate a number of vacant parking plots in the first zone, and when the data processing apparatus determines that the vehicle enters into the first zone and the number of vacant parking plots is greater than zero, the counter decreases the number of vacant parking plots by one.

6. The object location confirmation system as claimed in claim 1, wherein:
the data processing apparatus further comprises an information identification device and a processing device electrically connected to the information identification device; and
the information identification device is configured to identify the first datum to generate the identification information corresponding to the object, and the processing device is configured to determine and record that the object is located in the first zone.

7. The object location confirmation system as claimed in claim 1, wherein the data processing apparatus is further connected to an indicating device, and the indicating device is configured to indicate that the object is located in the first zone.

8. An object location confirmation system for use in an area, the area including a first zone and a second zone adjacent to the first zone, the object location confirmation system comprising:
a first data reading device disposed on a path of the area, being configured to retrieve a first datum related to an object and obtain a piece of identification information corresponding to the object according to the first datum;
a second data reading device disposed in a boundary region of the second zone; and
a data processing apparatus connected to the first data reading device and the second data reading device respectively, wherein when the data processing apparatus receives the identification information from the first data reading device but has not received the identification information from the second reading device by retrieving a second datum related to the object and obtaining the identification information corresponding to the object according to the second datum by the second data reading device, the data processing apparatus determines and records that the object is located in the first zone.

9. The object location confirmation system as claimed in claim 8, wherein each of the first data reading device and the second data reading device is a radio frequency identification (RFID) device, the first datum and the second datum are a first RF signal and a second RF signal from an RFID tag of the object respectively, and the identification information is an RFID code.

10. The object location confirmation system as claimed in claim 8, wherein:
the object is a vehicle;
each of the first data reading device and the second data reading device comprises a video camera and an identifying element electrically connected to the video camera, the video camera of each of the first data reading device and the second data reading device is configured to retrieve the first datum and the second datum related to the vehicle respectively, and each of the first datum and the second datum is an image; and
the identifying element of the first data reading device identifies the first datum and generates the identification information corresponding to the vehicle, and the identification information is one of a vehicle license plate identification code and a parking permit serial number.

11. The object location confirmation system as claimed in claim 10, wherein the data processing apparatus further comprises a counter configured to calculate a number of vacant parking plots in the first zone, and when the data processing apparatus determines that the vehicle enters into the first zone and the number of vacant parking plots is greater than zero, the counter decreases the number of vacant parking plots by one.

12. The object location confirmation system as claimed in claim 8, wherein:
the object is a vehicle;
the first data reading device further obtains a piece of auxiliary identification information corresponding to the vehicle according to the first datum;
the second data reading device is configured to retrieve the second datum related to the vehicle and obtain the auxiliary identification information corresponding to the vehicle according to the second datum; and
the data processing apparatus receives the auxiliary identification information corresponding to the vehicle that is obtained according to the first datum and the auxiliary identification information corresponding to the vehicle that is obtained according to the second datum, and incorporates the second zone into the first zone.

13. The object location confirmation system as claimed in claim 12, wherein:
each of the first data reading device and the second data reading device comprises a video camera and an identifying element electrically connected to the video camera, the video camera of each of the first data reading device and the second data reading device is configured to retrieve the first datum and the second datum related to the vehicle respectively, and each of the first datum and the second datum is an image; and
the identifying element of the first data reading device identifies the first datum and generates the identification information and the auxiliary identification information corresponding to the vehicle, the identifying element of the second data reading device identifies the second datum and generates the auxiliary identification information corresponding to the vehicle, the identification information is one of a vehicle license plate identification code and a parking permit serial number, and the auxiliary identification information is one of a color and a manufacturer's brand of the vehicle.

14. The object location confirmation system as claimed in claim 8, wherein the data processing apparatus is further connected to an indicating device, and the indicating device is configured to indicate that the object is located in the first zone.
